(19) United States
(12) Patent Application Publication
(10) Pub. No.: US 2008/0173483 A1
(43) Pub. Date: Jul. 24, 2008

(54) IMPLEMENT HAVING A HYDRAULIC TRACTION DRIVE AND METHOD OF USING THE SAME

(75) Inventor: EDWARD WALTER PHELPS, SALINE, WI (US)

Correspondence Address: SHUTTLEWORTH & INGERSOLL, P.L.C., 115 3RD STREET SE, SUITE 500, P.O. BOX 2107, CEDAR RAPIDS, IA, 52406, US

(73) Assignee: SWEEPSTER ATTACHMENTS, LLC, DEXTER, MI (US)

(21) Appl. No.: 11/625,866

(22) Filed: Jan. 23, 2007

(51) Int. Cl. B60K 25/00

(52) U.S. Cl. 180/53.4

(57) ABSTRACT

An implement adapted to be combined with a prime mover vehicle. The implement comprises a piece of equipment such as a rotary broom sweeper. The implement generally comprises a frame carried by wheels, an axle combined with the wheels, and a hydraulic system that includes a hydraulic pump and a hydraulic motor. As the prime mover moves the implement, the wheels of the implement turn. The wheels are operatively combined with the hydraulic pump to actuate the flow of hydraulic fluid through the hydraulic system. The hydraulic system actuates the piece of equipment carried by the implement.

### BACKGROUND OF THE INVENTION

There are many implements used in industrial, agricultural, and landscaping operations. Although some of these implements comprise their own drive means, most of them are pulled or pushed by a prime mover vehicle such as a pick up truck, dump truck, four-wheeler, skid steer loader, or tractor. Many implements comprise a piece of equipment that performs a function that requires a power source. For example, a rotary sweeper broom implement requires a power source to rotate the broom around its horizontal axis, and a seed spreader implement requires a power source to rotate a disk that throws seed outward from the spreader.

The equipment on most prior art implements obtains its power from the prime mover vehicle through electric, hydraulic, or mechanical means. An example of this is disclosed in U.S. Pat. No. 6,702,208 (Hadler). The device disclosed in the Hadler patent is an implement having a spreader actuated by a hydraulic motor which obtains its power from the hydraulic system of the prime mover vehicle. One problem with implements that obtain their power from the prime mover is that they can only be pulled by prime movers that have the necessary electric cables, hydraulic hoses, or mechanical shafts to power the implement.

Instead of obtaining power directly from the prime mover, some prior art implements have equipment that indirectly derive their power from the prime mover through a traction drive system. In most traction drive systems, the implement comprises wheels that rotate as the implement is being pulled or pushed by the prime mover. The implement wheels turn an axle having a sprocket/chain assembly that mechanically powers the implement's device. Examples of these types of ground wheel drive implements are described in U.S. Pat. No. 4,259,872 (Chandler) and U.S. Pat. No. 3,951,312 (Gay). One problem with these prior art mechanical ground wheel drive implements is that they comprise many moving parts that need adjusting and are prone to wear.

### SUMMARY

The present invention is an implement adapted to be combined with a prime mover vehicle. The prime mover vehicle is adapted to push or pull the implement over a ground surface. The implement generally comprises a frame supported by wheels, an axle combined with the wheels, a hydraulic system that includes a hydraulic pump and a hydraulic motor, and a piece of equipment such as a rotary broom sweeper. As the prime mover moves the implement, the wheels rotate due to the friction created between the wheels and the ground surface. The wheels are operatively combined with the hydraulic pump to actuate the flow of hydraulic fluid through the hydraulic system. The hydraulic system actuates the piece of equipment carried by the implement.

### BRIEF DESCRIPTION OF THE DRAWING

FIG. 1 is a perspective view of an embodiment of the implement combined with a rotary sweeper broom;

FIG. 2 is an exploded view of an embodiment of the implement;

FIG. 3 is a side view of an embodiment of the implement combined with a rotary sweeper broom;

FIG. 4 is a perspective view of an embodiment of the axle where a clutch is used to selectively engage and disengage the operative connection between the wheels and the fluid pump;

FIG. 5 is a detailed perspective view showing the axle sprocket and the gearbox sprocket combined with a chain;

FIG. 6 is an exploded view showing embodiment of the invention wherein the hydraulic pump is directly combined to the wheels without a mechanical linkage;

FIG. 7 is a schematic view of an embodiment of the hydraulic circuit; and

FIG. 8 is a side view of the gearbox showing the input shaft and output shaft in phantom lines inside the gearbox.

### DETAILED DESCRIPTION OF THE INVENTION

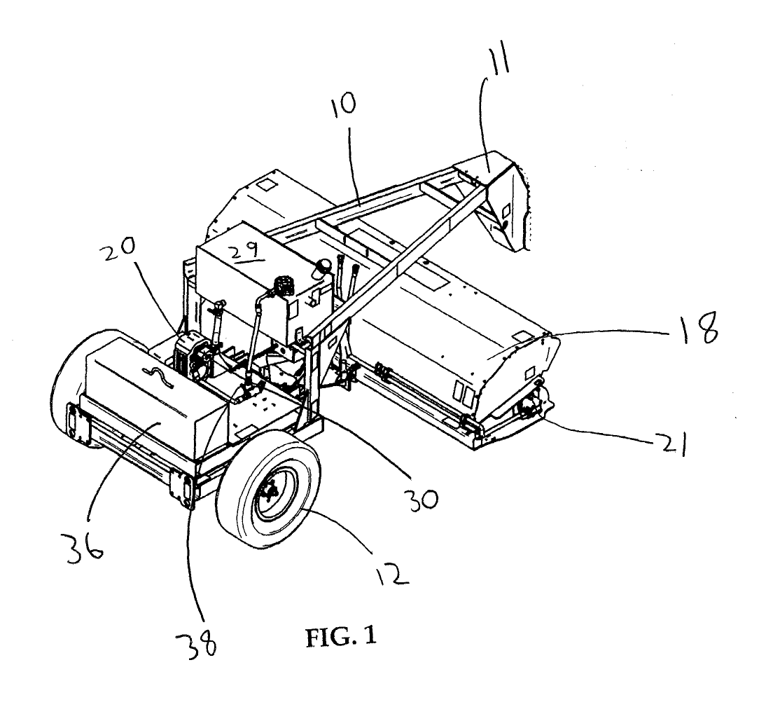

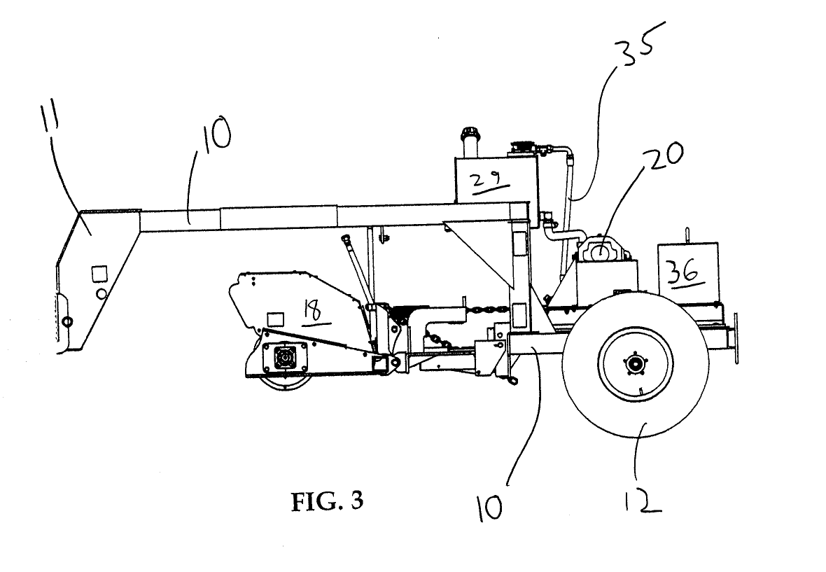

The present invention is an implement adapted to be combined with a prime mover vehicle. The prime mover vehicle is adapted to push or pull the implement over a ground surface. The implement may be combined with the prime mover by any suitable means, such as the hitch 11 shown in FIG. 1. As seen in FIGS. 1, 2, and 3, the implement generally comprises a frame 10 supported by wheels 12, an axle 14 combined with the wheels 12, a gearbox 20, a hydraulic system that includes a hydraulic pump 30, a hydraulic motor 21, and a hydraulic tank 29, and a piece of equipment 18 such as a rotary sweeper. In one preferred embodiment wherein the equipment 18 is a rotary sweeper, the diameter of the wheels is about twenty-nine inches. It should be noted that instead of wheels 12, an endless track or other suitable means may be used to roll the implement over the ground surface. It should also be noted that although the invention is described herein as using hydraulic fluid in a hydraulic system, any other suitable fluid may be used.

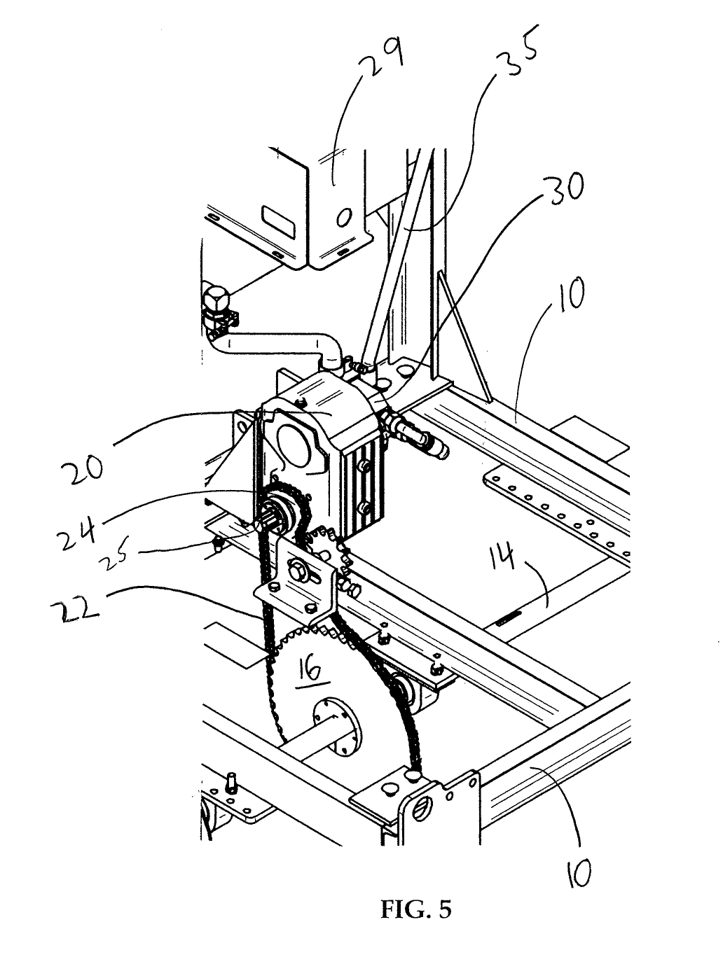

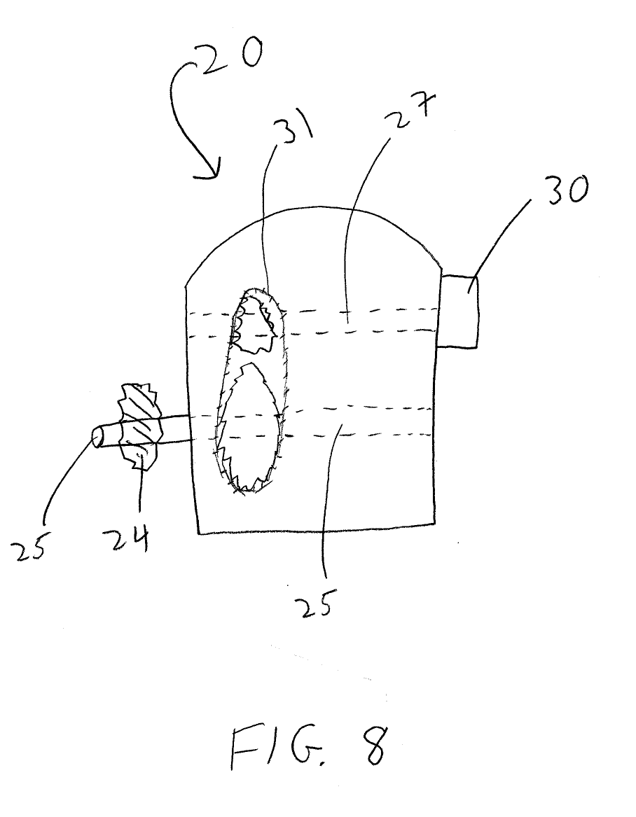

In use, as the prime mover moves the implement over the ground surface, the wheels 12 on the implement rotate due to the friction created between the wheels 12 and the ground surface. The rotation of the wheels 12 is used to actuate the hydraulic pump 30. In the embodiment shown in FIGS. 1-5, the wheels 12 indirectly actuate the hydraulic pump 30 through a mechanical linkage that may include an axle 14, sprockets 16, 24, a gearbox 20, and a chain 22. The mechanical linkage may function as follows. The rotation of the wheels 12 causes rotation of the axle 14. The axle 14 has a sprocket 16 mounted thereon so that rotation of the axle 14 causes rotation of the axle sprocket 16. The gearbox sprocket 24 (see FIG. 5) is operatively combined with the axle sprocket 16 by a member such as a gear or chain 22 so that movement of the axle sprocket 16 causes the gearbox sprocket 24 to rotate. As seen in FIG. 8, the gearbox 20 comprises an input shaft 25 and an output shaft 27 operatively combined by a gear or chain 31. The input shaft 25 is operatively combined with and driven by the gearbox sprocket 24. The output shaft 27 is operatively combined with the hydraulic pump 30 so that rotation of the output shaft 27 actuates the hydraulic pump 30. The hydraulic pump 30 is used to pump hydraulic fluid through the hydraulic system which actuates the hydraulic motor 21. The hydraulic motor 21 is operatively combined with and actuates the piece of equipment 18 carried by the implement.

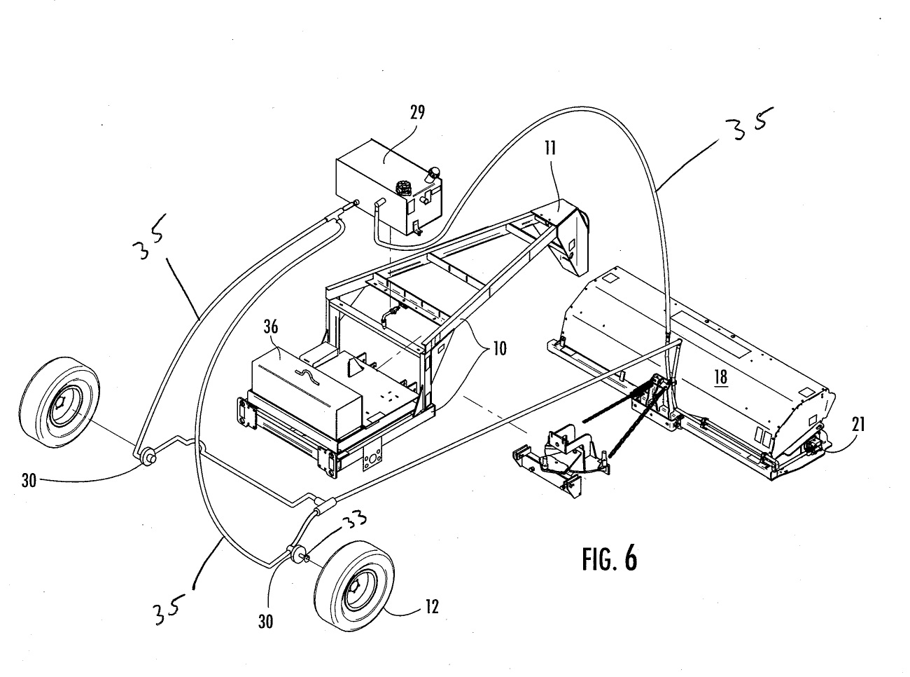

In an alternate embodiment shown in FIG. 6, the hydraulic pump 30 may be driven directly by the wheels 12. In other words, this embodiment does not need to include the mechanical linkage (axle 14, axle sprocket 16, chain 22, and gearbox 20). Instead, the hydraulic pump 30 comprises a drive shaft 33 that is operatively engaged with the wheels 12. The drive shaft 33 is rotated by the wheels 12 to actuate the fluid pump 30. As in the previous embodiment, the fluid pump 30 is used to pump hydraulic fluid through the hydraulic system which actuates the piece of equipment 18 carried by the implement.

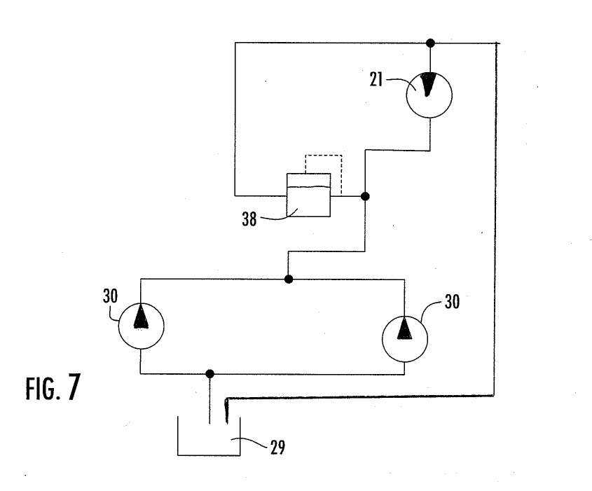

FIG. 7 schematically shows an embodiment of a hydraulic system that may be used with the present invention wherein reference number 29 identifies a hydraulic tank, reference number 30 identifies a hydraulic pump, reference number 38 identifies a pressure control means, and reference number 21 identifies a hydraulic motor. FIG. 6 shows hydraulic lines 35 connecting the various components of the hydraulic system.

The invention comprises various embodiments for modifying the flow rate of fluid through the hydraulic system to change the amount of power delivered to the piece of equipment 18. This is desirable since the invention can be used for a variety of different pieces of equipment 18 that may require different amounts of power. One way to change the flow rate of hydraulic fluid through the hydraulic system is to change the ground speed of the prime mover vehicle. As the ground speed increases, the power being delivered to the equipment 18 increases because the wheels 12 rotate faster which increases the rate that fluid is driven through the hydraulic system. In certain situations, however, it is desirable to be able to change the amount of power being delivered to the equipment 18 independent of ground speed. One of ordinary skill in the art will recognize that the power delivered to the equipment may be modified by changing the size and/or ratio of any number of items used with the present invention, including the gears 16, 24, pump 30, motor 21, or tires 12.

In one embodiment, the ratio of the diameter of the axle sprocket 16 relative to the diameter of the gearbox sprocket 24 may be modified to change the rotational speed of the output shaft 27. This can be done by changing the diameter of either of the sprockets 16, 24 or by having sprockets of various sizes mounted on their respective shafts 14, 25 so that changing the relative position of the shafts 14, 25 changes the gear ratio (similar to changing gears on a ten-speed bicycle). In one preferred embodiment wherein the implement is combined with a rotary sweeper 18, the preferred ratio between the axle sprocket 16 and the gearbox sprocket 24 is about 4.8:1.

In the embodiment seen in FIG. 8, the input shaft 25 has a sprocket and the output shaft 27 has a sprocket. These sprockets are operatively combined by a chain 31 or a gear. In this embodiment, the ratio of the diameter of the input shaft 25 sprocket relative to the diameter of the output shaft 27 sprocket can be modified to obtain various rotational speeds of the output shaft 27 at various ground speeds of the prime mover. This can be done by changing the diameter of either of the sprockets or by having sprockets of various sizes mounted on their respective shafts 25, 27 so that changing the position of the shafts 25, 27 changes the gear ratio (similar to changing gears on a ten-speed bicycle). In one preferred embodiment wherein the implement is combined with a rotary sweeper 18, the preferred ratio between the size of the input shaft 25 sprocket to the output shaft 27 sprocket is about 5:1.

In another embodiment, the user can control the power being delivered to the equipment 18 by changing the amount of pressure in the hydraulic system. This can be done by using a pressure control means 38. In one embodiment, the pressure control means 38 may be a relief valve. The relief valve may be set so that if fluid pressure builds up to a predetermined value in the hydraulic system, the relief valve is opened and hydraulic pressure is released. This allows the user to set a maximum upper value on the amount of hydraulic pressure created by the hydraulic system. In one embodiment, the relief valve is set to bypass fluid when the pressure builds up to between 2000 and 2500 pounds per square inch (PSI).

In another embodiment, the pressure control means 38 may be an adjustable flow divider. The adjustable flow divider preferably comprises a pre set relief so the user can control the rate of hydraulic fluid through the system. This design allows the prime mover to travel at a wide range of ground speeds while allowing the user to control the amount of power generated by the hydraulic system. The adjustable flow divider allows fluid provided by the hydraulic pump 30 to be divided into a controlled flow and an exhaust flow. By adjusting the flow divider, the controlled flow can be adjusted to vary the speed of the hydraulic motor 21.

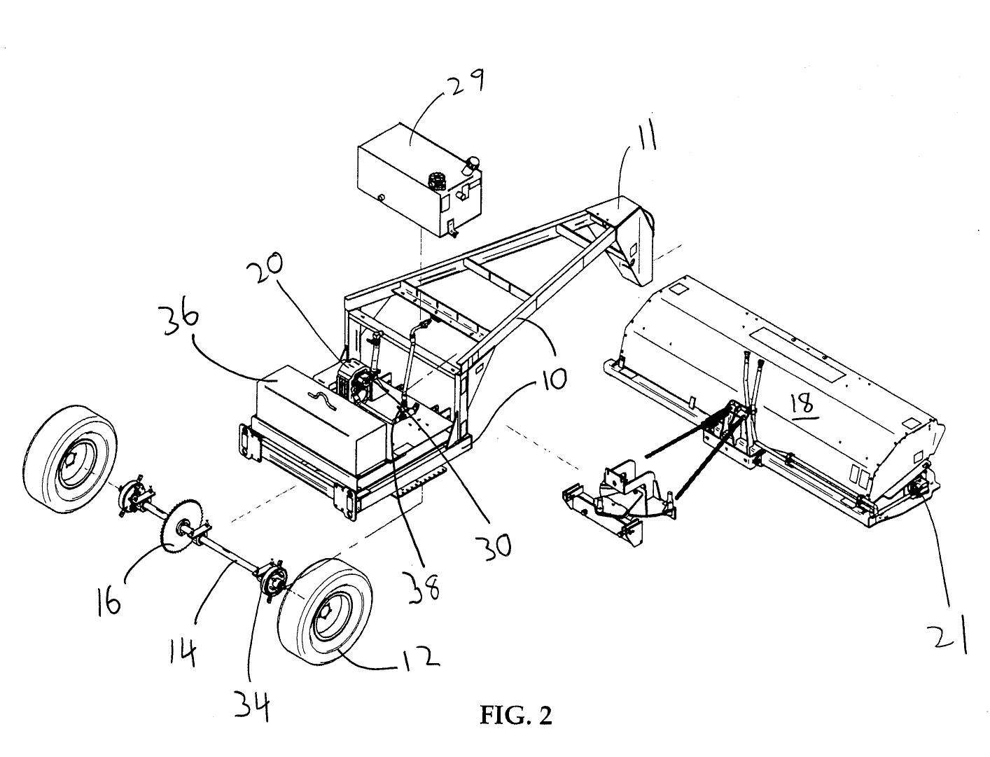

In addition to allowing the user to vary the amount of power created by the hydraulic system, some embodiments of the invention comprise means for allowing the user to selectively engage and disengage the pump 30 so as to control when the pump 30 is pumping hydraulic fluid. In other words, in some embodiments, the pump 30 can be turned on and off. In the embodiment shown in FIGS. 1 and 2, the implement comprises drive hubs 34 which are located between the wheels 12 and the axle 14. The drive hubs 34 have an engaged position and a disengaged position. In the engaged position, the drive hubs 34 allow the wheels 12 to turn the axle 14. In the disengaged position, the drive hubs 34 do not allow the wheels 12 to turn the axle 14.

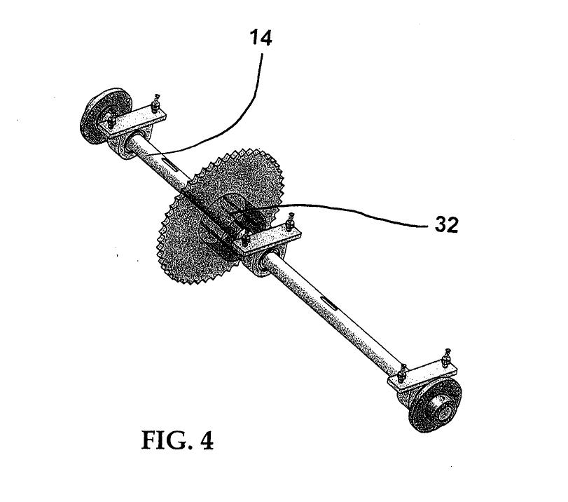

In an alternate embodiment shown in FIG. 4, a clutch 32 is used to engage and disengage the rotation of the sprocket 14 relative to the axle 14. The clutch 32 is shown operatively combined with the axle 14 in FIG. 4. The clutch 32 could be electric or manual with an electric actuator to activate the clutch 32. This clutch 32 is coupled to the axle 14 via keyed shaft and hub.

FIGS. 1-3 show that in some embodiments of the invention the implement may comprise a weight 36 to increase friction between the wheels 12 and the ground surface and help reduce slippage. In the embodiment shown in FIGS. 1 and 2, the weight 36 is in the form of a weight box that is welded to the frame 10 of the implement. The weight box may be opened and closed and is adapted to receive any suitable weight, such as cement, water, sand, rocks, or steel slugs. In one embodiment, the weight 36 carried by the frame 10 is about between 850 and 900 pounds.

Having thus described the invention in connection with the preferred embodiments thereof, it will be evident to those skilled in the art that various revisions can be made to the preferred embodiments described herein with out departing from the spirit and scope of the invention. It is my intention, however, that all such revisions and modifications that are evident to those skilled in the art will be included with in the scope of the following claims.

What is claimed is as follows:

1. An implement adapted to be connected to a prime mover for movement over the ground, said implement comprising:
a frame;
at least one wheel combined with the frame;
a fluid pump operatively combined with the wheel;
a fluid motor in communication with the fluid pump; and
a piece of equipment carried by the implement and driven by the fluid motor.

2. An implement adapted to be connected to a prime mover for movement over the ground, said implement comprising:
a frame;
a means for rolling the implement over the ground surface;
a means for actuating a fluid pump using the rotational movement of the rolling means;
a fluid motor in communication with the fluid pump; and
a piece of equipment carried by the implement and driven by the fluid motor.

3. An implement adapted to be connected to a prime mover for movement over the ground, said implement comprising:
a frame;
a first wheel and a second wheel combined with the frame and connected by an axle;
a first sprocket combined with the axle;
a gearbox having an input shaft operatively combined with an output shaft;
a second sprocket combined with the gearbox input shaft;
a member for operatively combining the first sprocket with the second sprocket;
a hydraulic pump operatively combined with and driven by the gearbox output shaft;
a hydraulic motor in communication with the hydraulic pump; and
a piece of equipment carried by the implement and driven by the hydraulic motor.

4. The implement of claim 3 wherein the equipment is a sweeper.

5. The implement of claim 3 wherein the member combining the first sprocket and the second sprocket is a chain.

6. The implement of claim 3 further comprising an adjustable flow divider having a pre-set relief device to control the rate of hydraulic fluid through the hydraulic motor.

7. The implement of claim 3 further comprising a relief valve for providing a maximum upper value for the amount of hydraulic pressure created by the hydraulic pump.

8. The implement of claim 3 wherein the ratio of the diameter of the first sprocket and the second sprocket is about 4.8:1.

9. The implement of claim 3 wherein the input shaft further comprises an input shaft sprocket and the output shaft further comprises an output shaft sprocket.

10. The implement of claim 9 wherein the input shaft sprocket and the output shaft sprocket are combined by a chain.

11. The implement of claim 10 wherein the ratio of the diameter of the input shaft sprocket and the output shaft sprocket is about 5:1.

12. The implement of claim 3 further comprising a weight to increase friction between the wheels and the ground surface and help reduce slippage.

13. The implement of claim 12 wherein the weight is about between 850 and 900 pounds.

14. The implement of claim 3 further comprising a weight box combined with the frame and adapted to receive additional weight to increase friction between the wheels and the ground surface and help reduce slippage.

15. The implement of claim 14 wherein the weight box has an open position and a closed position.

16. The implement of claim 3 further comprising drive hubs between the wheels and the axle for selectively engaging and disengaging the rotation of the axle relative to the rotation of the wheels.

17. The implement of claim 16 wherein the drive hubs have an engaged position in which the axle is rotated by the wheels and a disengaged position in which the axle is not rotated by the wheels.

18. The implement of claim 3 further comprising a clutch combined with the axle for selectively engaging and disengaging the rotation of the first sprocket relative to the rotation of the axle.

19. The implement of claim 18 wherein the clutch has an engaged position in which the axle rotates the first sprocket and a disengaged position in which the axle does not rotate the first sprocket.

20. A method for hydraulically actuating a piece of equipment carried by an implement wherein the implement is adapted to be connected to a prime mover vehicle, said implement having a frame carried by wheels, and a hydraulic system that includes a hydraulic pump and a hydraulic motor, said method comprising the steps of:
moving the implement with the prime mover vehicle to cause the wheels to rotate;
transferring energy from the rotating wheels to the hydraulic pump;
pumping hydraulic fluid through the hydraulic system;
actuating the piece of equipment carried by the implement using the hydraulic motor.

21. The method of claim 20 wherein the implement further comprises an axle combining the wheels; and
drive hubs between the wheels and the axle.

22. The method of claim 21 further comprising the step of selectively engaging and disengaging the rotation of the axle using the drive hubs so as to engage and disengage the hydraulic pump.

23. The method of claim 20 wherein the implement further comprises an axle;
a clutch combined with the axle; and
a sprocket combined with the axle.

24. The method of claim 23 further comprising the step of selectively engaging and disengaging the axle and the sprocket using the clutch so as to engage and disengage the hydraulic pump.

25. The method of claim 20 wherein the implement further comprises an adjustable flow divider.

26. The method of claim 20 further comprising the step of using the adjustable flow divider to control the rate of hydraulic fluid through the system.
